(19) United States
(12) Patent Application Publication
(10) Pub. No.: US 2019/0315554 A1
(43) Pub. Date: Oct. 17, 2019

(54) HEAT-REFLECTIVE BLANK AND CONTAINER AND METHOD OF FORMING A HEAT-REFLECTIVE BLANK AND CONTAINER

(71) Applicant: WestRock Shared Services, LLC, Norcross, GA (US)

(72) Inventors: Paul C. HASCHKE, Carol Stream, IL (US); Owen GLOCK, Valparaiso, IN (US)

(21) Appl. No.: 16/447,405

(22) Filed: Jun. 20, 2019

Related U.S. Application Data
(62) Division of application No. 15/618,599, filed on Jun. 9, 2017.
(60) Provisional application No. 62/359,893, filed on Jul. 8, 2016.

(51) Int. Cl. B65D 81/38; B31F 1/28; B32B 29/00; B65D 81/26; B65D 5/56; B65D 5/22; B65D 5/66

(52) U.S. Cl. CPC B65D 81/3858; B31F 1/2813; B32B 29/00; B65D 81/264; B31B 50/00; B65D 5/22; B65D 5/6664; B65D 5/563; B65D 2585/366; B65D 5/56

(57) ABSTRACT

A method for forming a heat-reflective blank includes laminating at least one thermal film sheet at a predetermined position on a first linerboard sheet such that a laminated sheet is formed, and feeding the laminated sheet into a corrugating machine. The method further includes coupling the laminated sheet to a corrugated medium sheet and a second linerboard sheet such that a corrugated sheet is formed. The corrugated medium sheet is between the first linerboard sheet and the second linerboard sheet and the thermal film sheet is positioned on an outer surface of the corrugated sheet.

### CROSS-REFERENCE TO RELATED APPLICATIONS

This application is a Divisional application of U.S. patent application Ser. No. 15/618,599 filed Jun. 9, 2017, which claims the benefit of U.S. Provisional Application Ser. No. 62/359,893 filed Jul. 8, 2016, all of which are entitled “HEAT-REFLECTIVE BLANK AND CONTAINER AND METHOD OF FORMING A HEAT-REFLECTIVE BLANK AND CONTAINER” and the contents of all of which are incorporated herein by this reference.

### BACKGROUND OF THE INVENTION

The embodiments described herein relate generally to a blank of sheet material having a thermal film coupled thereto and, more particularly, to a heat-reflective blank and container, and method of forming a heat-reflective blank and container.

At least some known containers are used for storing and/or transporting a heated or cooled product therein. At least one such container includes a radiant barrier coupled to an interior and/or exterior surface of a top panel after forming the container. The radiant barrier reflects heat back to the product within the container to facilitate maintaining the temperature of the product. However, such containers have been prevented from entering the market because mass production of such containers has not been possible. More specifically, cutting the radiant barrier and coupling the radiant barrier to the blank have been too time consuming and/or costly for mass production.

As such, it is desirable to provide a method for mass producing a heat-reflective container for retaining heat within the container. Further, it is desirable to provide a method for coupling a heat-reflective film to a blank that is time and cost effective.

### BRIEF DESCRIPTION OF THE INVENTION

In one aspect, a method for forming a heat-reflective blank is provided. The method includes laminating at least one thermal film sheet at a predetermined position on a first linerboard sheet such that a laminated sheet is formed, and feeding the laminated sheet into a corrugating machine. The method further includes coupling the laminated sheet to a corrugated medium sheet and a second linerboard sheet such that a corrugated sheet is formed. The corrugated medium sheet is between the first linerboard sheet and the second linerboard sheet and the thermal film sheet is positioned on an outer surface of the corrugated sheet.

In another aspect, a container from a heat-reflective blank of foldable corrugated sheet material is provided. The corrugated sheet material includes a corrugated medium coupled between a first linerboard and a second linerboard. The container includes a top portion including a top panel, a first side panel, and an opposite second side panel. The container further includes an integrated thermal film formed on at least a portion of an interior side the top panel, the first side panel, and the second side panel. The thermal film is laminated on the first linerboard and configured to reflect heat into the container.

In yet another aspect, a container from a heat-reflective blank of foldable corrugated sheet material is provided. The sheet material includes a corrugated medium coupled between a first linerboard and a second linerboard. The container includes a top portion including a top panel, a first side panel, and an opposite second side panel, wherein the top panel includes a front edge, rear edge, a first side edge, and a second side edge. At least one venting assembly comprising a first vent panel and a second vent panel hingedly connected to the first vent panel. The first and second vent panels having a least partially free side edges, the partially free side edges at least partially defining an opening at each end of the at least one venting assembly. The at least one venting assembly is positioned along one or more of the front edge, the rear edge, the first side edge, and the second side edge. The container further includes an integrated thermal film formed on at least a portion of an interior side the top panel, the first side panel, and the second side panel. The thermal film is laminated on the first linerboard and configured to reflect heat into the container.

### BRIEF DESCRIPTION OF THE DRAWINGS

FIGS. 1-10 show exemplary embodiments of the system and method described herein.

FIG. 1 is a top plan view of a heat-reflective blank of sheet material for constructing a heat-reflective container, according to one embodiment of the present disclosure.

FIG. 2 is a perspective view of a heat-reflective container formed from the heat-reflective blank shown in FIG. 1.

FIG. 3 is a top plan view of a heat-reflective blank of sheet material for constructing a heat-reflective container, according to a second embodiment of the present disclosure.

FIG. 4 is a perspective view of a heat-reflective container formed from the heat-reflective blank shown in FIG. 3.

FIG. 5 is a schematic side view of a laminating machine for forming the heat-reflective blanks shown in FIGS. 1 and 3.

FIG. 6 is a plan view of a laminated sheet material that may be formed from the laminating machine shown in FIG. 5.

FIG. 7 is a plan view of an alternative embodiment of the laminated sheet material that may be formed from the laminating machine shown in FIG. 5.

FIG. 8 is a schematic side view of a first section of a corrugating machine for forming the heat-reflective blanks shown in FIGS. 1 and 3.

FIG. 9 is a schematic side view of a second section of the corrugating machine shown in FIG. 8.

FIG. 10 is a cross-sectional view of a corrugated sheet material that may be formed from the corrugating machine shown in FIGS. 8 and 9.

### DETAILED DESCRIPTION OF THE INVENTION

The following detailed description illustrates the disclosure by way of example and not by way of limitation. The description clearly enables one skilled in the art to make and use the disclosure, describes several embodiments, adaptations, variations, alternative, and use of the disclosure, including what is presently believed to be the best mode of carrying out the disclosure.

The present invention provides a heat-reflective container that includes a heat-reflective film, such as a thermal film, and a method for constructing a heat-reflective blank. The heat-reflective blank is at least partially constructed using a machine. In one embodiment, the blank is fabricated from a corrugate material. The blank, however, may be fabricated using any suitable material, and therefore is not limited to a specific type of material. In alternative embodiments, the blank is fabricated using cardboard, plastic, fiberboard, paperboard, foamboard, corrugated paper, and/or any suitable material known to those skilled in the art and guided by the teachings herein provided. The heat-reflective blank described herein may or may not include a cutout over which the thermal film is applied.

For purposes of this disclosure, the container referred to herein is a container formed from a blank of sheet material including the heat-reflective film attached thereto. As such, the heat-reflective blank referred to herein is the blank of sheet material with the heat-reflective film coupled thereto prior to the heat-reflective blank being formed into the container.

In an example embodiment, the heat-reflective container and/or a heat-reflective film includes at least one marking thereon including, without limitation, indicia that communicates the product, a manufacturer of the product and/or a seller of the product. For example, the marking may include printed text that indicates a product's name and briefly describes the product, logos and/or trademarks that indicate a manufacturer and/or seller of the product, and/or designs and/or ornamentation that attract attention. In another embodiment, the container is void of markings, such as, without limitation, indicia that communicates the product, a manufacturer of the product and/or a seller of the product. Furthermore, the container may have any suitable size, shape and/or configuration, i.e., any suitable number of sides having any suitable size, shape and/or configuration as described and/or illustrated herein. In one embodiment, the container includes a shape that provides functionality, such as a shape that facilitates packaging a food item, a shape that facilitates transporting the container, and/or a shape that facilitates stacking and/or arrangement of a plurality of containers.

In the example embodiment, the blank and/or container includes a heat-reflective, or thermal, film applied to an interior surface of the blank. When the container is formed from the heat-reflective blank, the heat-reflective film is positioned adjacent a product within the container to facilitate maintaining a temperature of the product and/or prolonging a cooling period of the product. In one embodiment, the product is a heated pizza, and the heat-reflective film reflects the heat emitted from the pizza back towards the pizza such that the cooling of the pizza is delayed. More specifically, the heat-reflective film reflects heat from an upper surface of the pizza back onto the pizza to maintain the temperature of the pizza for a longer time as compared to conventional pizza containers. Further, the heat-reflective film is formed with the blank using a machine that attaches the heat-reflective film to a linerboard layer before forming the corrugation layers of the blank. The machine can also stack the heat-reflective blanks. The machine enables more heat-reflective blanks to be formed in a shorter period of time as compared to other processes that couple the heat-reflective film to the blanks, such as using a windowing machine or manually cutting and gluing the heat-reflective film to the blanks.

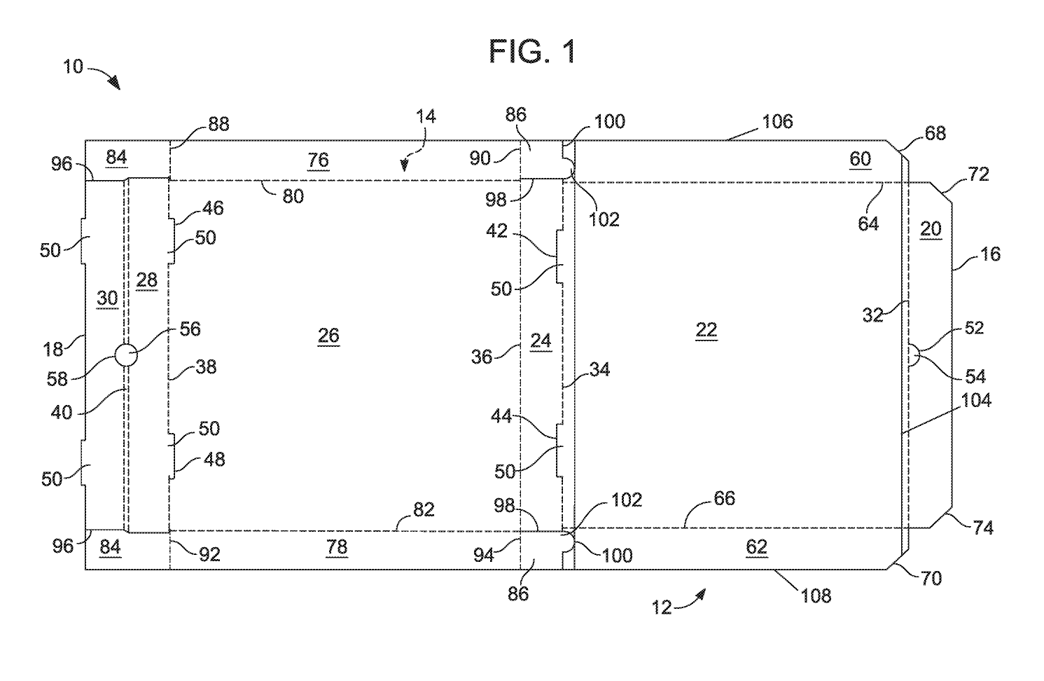

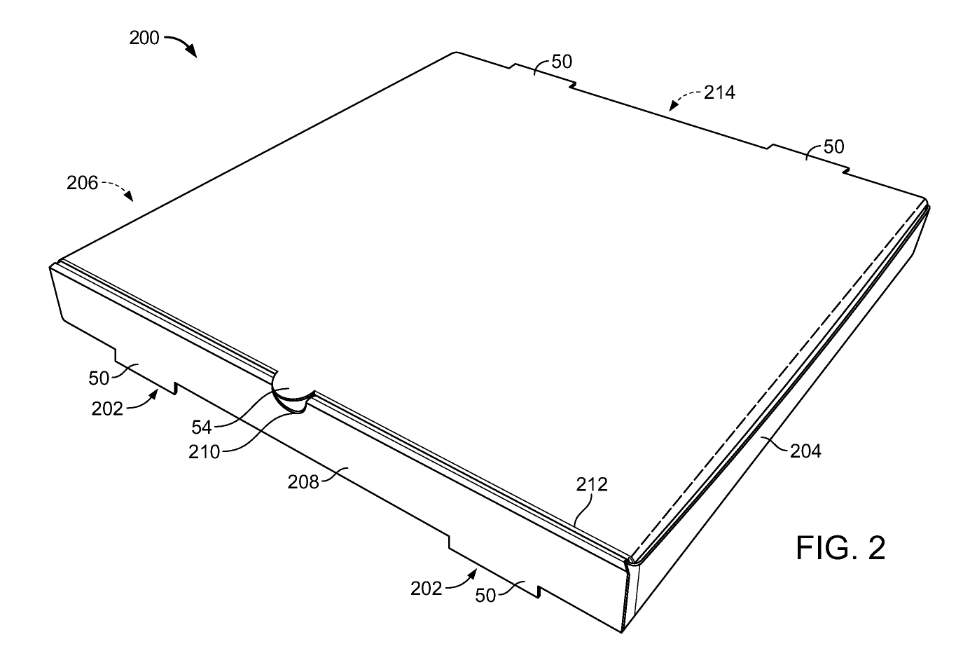

Referring now to the drawings, and more specifically to FIGS. 1 and 2, although as described above a container may have any suitable size, shape, and/or configuration, FIGS. 1 and 2 illustrate the construction or formation of one embodiment of a container from a blank of sheet material and a heat-reflective film (also referred to as a thermal film). Specifically, FIG. 1 is a top plan view of one embodiment of a heat-reflective blank 10 of sheet material that includes a thermal film 104. FIG. 2 is a perspective view of one embodiment of a container 200 formed from heat-reflective blank 10 shown in FIG. 1. Heat-reflective blank 10 is formed from a corrugated material in the exemplary embodiment.

Referring to FIG. 1, heat-reflective blank 10 has a first or interior surface 12 and an opposing second or exterior surface 14. Further, heat-reflective blank 10 defines a leading edge 16 and an opposing trailing edge 18. In one embodiment, heat-reflective blank 10 includes, from leading edge 16 to trailing edge 18, a tuck flap 20, a top panel 22, a back panel 24, a bottom panel 26, an outer front panel 28, and an inner front panel 30 coupled together along preformed, generally parallel, fold lines 32, 34, 36, and 38, and hinge line 40, respectively. More specifically, tuck flap 20 extends from top panel 22 along fold line 32, back panel 24 extends from top panel 22 along fold line 34, bottom panel 26 extends from back panel 24 along fold line 36, outer front panel 28 extends from bottom panel 26 along fold line 38, and inner front panel 30 extends from outer front panel 28 along hinge line 40. Fold lines 32, 34, 36, and 38, and hinge line 40, as well as other fold lines and/or hinge lines described herein, may include any suitable line of weakening and/or line of separation known to those skilled in the art and guided by the teachings herein provided.

In the exemplary embodiment, fold line 34 and 38 include cut lines 42 and 44, and 46 and 48, respectively. More specifically cut lines 42, 44, 46, and 48 define tab portions 50. When heat-reflective blank 10 is assembled to construct container 200 (shown in FIG. 2), tab portions 50 extend from each of top panel 22 and bottom panel 26 and define openings 202 (shown in FIG. 2) extending through container 200. Although cut lines 42 and 44 and tabs 50 are shown and described as extending from fold line 34 and/or top panel 22, fold line 34 and/or top panel 22 is not required to include cut lines 42 and 44 and tabs 50. Trailing edge 18 also includes defined tab portions 50 extending therefrom. In the exemplary embodiment, fold line 32 includes a cut line 52 that defines a semi-circular tab 54. Although tab 54 is shown and described as being semi-circular, tab 54 may be any other suitable shape that enables heat-reflective blank 10 and/or container 200 to function as described herein, or heat-reflective blank 10 may include fold line 32 having no cut line 52 and/or tab 54. Furthermore, in the exemplary embodiment, hinge line 40 includes a cut-out portion 56 defined by a cut line 58. Although cut-out portion 56 is shown as substantially circular, cut-out portion 56 may be any shape, such as but not limited to being, square, rectangular, oblong, irregular, and/or any other shape that enables heat-reflective blank 10 and/or container 200 to function as described herein. In one embodiment, hinge line 40 is substantially continuous and does not include cut-out portion 56 and/or cut line 58.

Top panel 22 includes a first top side panel 60 and a second top side panel 62 extending therefrom along respective fold lines 64 and 66. More specifically, first top side panel 60 extends from top panel 22 along fold line 64, and second top side panel 62 extends from top panel 22 along fold line 66. In the exemplary embodiment, first top side panel 60, second top side panel 62, and tuck flap 20 include respective angled edges 68, 70, 72, and 74. Although, in the exemplary embodiment, each side panel 60 and 62, and tuck flap 20 include respective angled edges 68, 70, 72, and 74, in other embodiments, some or none of side panels 60 and 62 and tuck flap 20 may include angled edges 68, 70, 72, and 74.

Bottom panel 26 includes a first bottom side panel 76 and a second bottom side panel 78 extending therefrom along respective fold lines 80 and 82. More specifically, first bottom side panel 76 extends from bottom panel 26 along fold line 80, and second bottom side panel 78 extends from bottom panel 26 along fold line 82. Furthermore, each bottom side panel 76 and 78 includes a front tab 84 and a back tab 86 extending from respective fold lines 88, 90, 92, and 94. More specifically, one front tab 84 extends from first bottom side panel 76 along fold line 88, one back tab 86 extends from first bottom side panel 76 along fold line 90, one front tab 84 extends from second bottom side panel 78 along fold line 92, and one back tab 86 extends from second bottom side panel 78 along fold line 94. Each front tab 84 is separated from outer front panel 28 and inner front panel 30 by a cut line 96. Each back tab 86 is separated from back panel 24 by a cut line 98, and further separated from respective top side panels 60 and 62 by a cut line 100. Although, in the exemplary embodiment, cut lines 100 define an extension portion 102, in other embodiments, cut lines 100 may be any suitable shape, size, and/or configuration that enables heat-reflective blank 10 and/or container 200 to function as described herein.

In the exemplary embodiment, heat-reflective blank 10 has a heat-reflective film or a thermal film 104 formed on at least a portion of interior surface 12. Heat-reflective blank 10 is used to form container 200. Thermal film 104 may be formed, for example, laminated, to heat-reflective blank 10 using a process with one or more machines, as described in more detail below. In the exemplary embodiment, thermal film 104 is formed to interior surface 12 of top panel 22 and substantially covers top panel 22. Additionally, thermal film 104 is formed to interior surface 12 of first top side panel 60 and second top side panel 62 and substantially covers each panel 60 and 62. Additionally and/or alternatively, thermal film 104 is coupled to interior surface 12 of any suitable panel(s). For example, tuck flap 20, back panel 24, bottom panel 26, and/or bottom side panels 76 and/or 78. Further, in the exemplary embodiment, thermal film 104 is for example, but not limited to, aluminum foil (with or without a protective coating), metalized polymer films (such as oriented polypropylene, polyethylene terephthalate, nylon, polyethylene, cast polypropylene, polyester, and/or polyvinyl chloride), metalized paper, and/or non-metalized polymer films.

To construct container 200 shown in FIG. 2 from heat-reflective blank 10 shown in FIG. 1, bottom side panels 76 and 78 are rotated about respective fold lines 80 and 82 toward interior surface 12 to form a generally right angle with bottom panel 26. Each bottom side panel 76 and 78 forms a respective bottom side wall 204 and 206. Front tabs 84 are each rotated about respective fold lines 88 and 92 toward interior surface 12 of each bottom side panel 76 and 78 to form a generally right angle with each bottom side panel 76 and 78. Outer front panel 28 is rotated about fold line 38 toward interior surface 12 to form a generally right angle with bottom panel 26. Exterior surface 14 of each front tab 84 is adjacent to interior surface 12 of outer front panel 28. Inner front panel 30 is rotated about hinge line 40 such that interior surface 12 of each front tab 84 is adjacent to interior surface 12 of inner front panel 30. As such, when inner front panel 30 is rotated about hinge line 40, front tabs 84 extend between inner front panel 30 and outer front panel 28. In the exemplary embodiment, tabs 50 extending from inner front panel 30 interconnect with openings 202 formed by tabs 50 extending from outer front panel 28 to facilitate securing inner front panel 30 against front tabs 84 and outer front panel 28. Outer front panel 28, inner front panel 30, and front tabs 84 define a bottom front wall 208. When front wall 208 is assembled, cut-out portion 56 defines an indentation 210 within a top edge 212 of front wall 208.

Each back tab 86 is rotated about respective fold lines 90 and 94 toward interior surface 12 to form a generally right angle with each respective bottom side panel 76 and 78. Back panel 24 is rotated about fold line 36 toward interior surface 12 to form a generally right angle with bottom panel 26. In the exemplary embodiment, exterior surface 14 of each back tab 86 is adjacent to interior surface 12 of back panel 24. Back panel 24 and back tabs 86 define a back wall 214. Each top side panel 60 and 62 is rotated about respective fold lines 64 and 66 toward interior surface 12 to form generally right angles with top panel 22. Each top side panel 60 and 62 define a top side wall (not shown). Tuck flap 20 is rotated about fold line 32 toward interior surface 12 to form a generally right angle with top panel 22. When tuck flap 20 is folded about fold line 32, tab 54 extends from top panel 22. To close container 200, top panel 22 is rotated about fold line 34 toward interior surface 12 to be aligned substantially parallel to bottom panel 26. When top panel 22 is rotated into place, exterior surface 14 of each top side panel 60 and 62 is adjacent to interior surface 12 of respective bottom side panels 76 and 78. Further, when top panel 22 is rotated into place, exterior surface 14 of tuck flap 20 is adjacent to exterior surface 14 of inner front panel 30. Once container 200 is constructed, container 200 may hold any suitable item or items, for example, but not limited to, a food item, such as, a pizza, and thermal film 104 is positioned adjacent the item, such as adjacent to a top surface of the item.

In the exemplary embodiment, thermal film 104 facilitates to increase the reflection of heat from the contents of container 200. For example, thermal film 104 may be square, rectangular, circular, and/or any suitable shape that enables reflection of heat from the contents. For example, when the pizza is substantially square, thermal film may be substantially square, and when the pizza is substantially circular, thermal film 104 may be substantially circular. Furthermore, tabs 50 and openings 202 facilitate raising container 200 and provide ventilation to the contents therein.

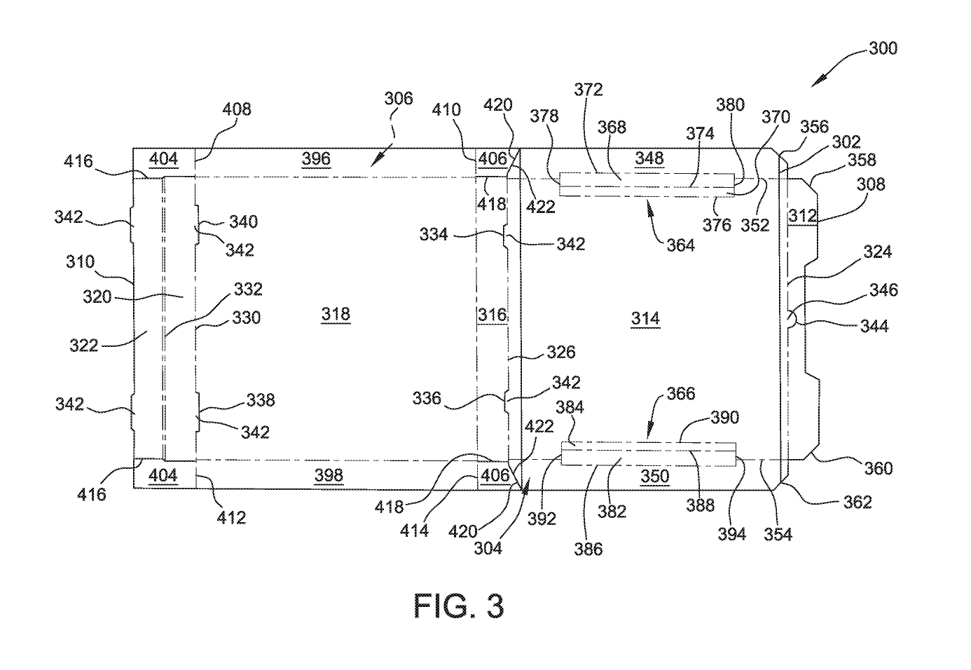

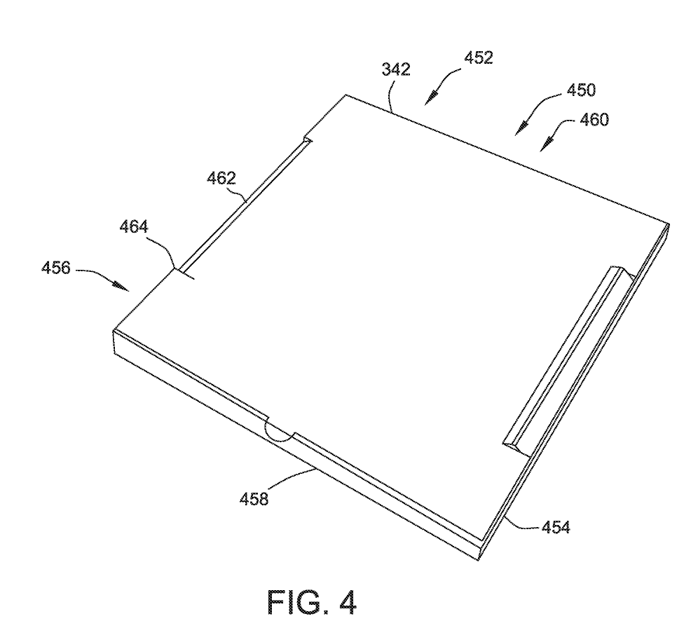

Referring to FIGS. 3 and 4, although as described above a container may have any suitable size, shape, and/or configuration, FIGS. 3 and 4 illustrate the construction or formation of a second embodiment of a container from a blank of sheet material and a heat-reflective film (also referred to as a thermal film). Specifically, FIG. 3 is a top plan view of the second embodiment of a heat-reflective blank 300 of sheet material that includes a thermal film 302. FIG. 4 is a perspective view of the second embodiment of a container 450 formed from heat-reflective blank 300 shown in FIG. 3. Heat-reflective blank 300 is formed from a corrugated material in the exemplary embodiment.

Referring to FIG. 3, heat-reflective blank 300 has a first or interior surface 304 and an opposing second or exterior surface 306. Further, heat-reflective blank 300 defines a leading edge 308 and an opposing trailing edge 310. In one embodiment, heat-reflective blank 300 includes, from leading edge 308 to trailing edge 310, a tuck flap 312, a top panel 314, a back panel 316, a bottom panel 318, an outer front panel 320, and an inner front panel 322 coupled together along preformed, generally parallel, fold lines 324, 326, 328, and 330, and hinge line 332, respectively. More specifically, tuck flap 312 extends from top panel 314 along fold line 324, back panel 316 extends from top panel 314 along fold line 326, bottom panel 318 extends from back panel 316 along fold line 328, outer front panel 320 extends from bottom panel 318 along fold line 330, and inner front panel 322 extends from outer front panel 320 along hinge line 332. Fold lines 324, 326, 328, and 330, and hinge line 332, as well as other fold lines and/or hinge lines described herein, may include any suitable line of weakening and/or line of separation known to those skilled in the art and guided by the teachings herein provided.

In the exemplary embodiment, fold line 326 and 330 include cut lines 334 and 336, and 338 and 340, respectively. More specifically cut lines 334, 336, 338, and 340 define tab portions 342. When heat-reflective blank 300 is assembled to construct container 450 (shown in FIG. 4), tab portions 342 extend from each of top panel 314 and bottom panel 318 and define openings 452 (shown in FIG. 4) extending through container 450. Although cut lines 334 and 336 and tabs 342 are shown and described as extending from fold line 326 and/or top panel 314, fold line 326 and/or top panel 314 is not required to include cut lines 334 and 336 and tabs 342. Trailing edge 310 also includes defined tab portions 342 extending therefrom. In the exemplary embodiment, fold line 324 includes a cut line 344 that defines a semi-circular tab 346. Although tab 346 is shown and described as being semi-circular, tab 346 may be any other suitable shape that enables heat-reflective blank 300 and/or container 450 to function as described herein, or heat-reflective blank 300 may include fold line 324 having no cut line 344 and/or tab 346.

Top panel 314 includes a first top side panel 348 and a second top side panel 350 extending therefrom along respective fold lines 352 and 354. More specifically, first top side panel 348 extends from top panel 314 along fold line 352, and second top side panel 350 extends from top panel 314 along fold line 354. In the exemplary embodiment, first top side panel 348, second top side panel 350, and tuck flap 312 include respective angled edges 356, 358, 360, and 362. Although, in the exemplary embodiment, each side panel 348 and 350, and tuck flap 312 include respective angled edges 356, 358, 360, and 362, in other embodiments, some or none of side panels 348 and 350 and tuck flap 312 may include angled edges 356, 358, 360, and 362.

In the exemplary embodiment, top panel 314 further includes vent assemblies 364 and 366 along at least a portion of respective fold lines 352 and 354. Vent assembly 364, located along at least a portion of fold line 352, includes a lower vent panel 368 and an upper vent panel 370. Lower vent panel 368 extends from top side panel 348 along fold line 372. Upper vent panel 370 extends from lower vent panel 368 along fold line 374. Top panel 314 extends from upper vent panel 370 along fold line 376. Cut lines 378 and 380 are located through top panel 314 and top side panel 348 at each end of vent assembly 364. In one embodiment, lower vent panel 368 has a greater width than upper vent panel 370. Similarly, vent assembly 366, is located along at least a portion of fold line 354, and includes a lower vent panel 382 and an upper vent panel 384. Lower vent panel 382 extends from top side panel 350 along fold line 386. Upper vent panel 384 extends from lower vent panel 382 along fold line 388. Top panel 314 extends from upper vent panel 384 along fold line 390. Cut lines 392 and 394 are located through top panel 314 and top side panel 350 at each end of vent assembly 366. In one embodiment, lower vent panel 382 has a greater width than upper vent panel 384.

Bottom panel 318 includes a first bottom side panel 396 and a second bottom side panel 398 extending therefrom along respective fold lines 400 and 402. More specifically, first bottom side panel 396 extends from bottom panel 318 along fold line 400, and second bottom side panel 398 extends from bottom panel 318 along fold line 402. Furthermore, each bottom side panel 396 and 398 includes a front tab 404 and a back tab 406 extending from respective fold lines 408, 410, 412, and 414. More specifically, one front tab 404 extends from first bottom side panel 396 along fold line 408, one back tab 406 extends from first bottom side panel 396 along fold line 410, one front tab 404 extends from second bottom side panel 398 along fold line 412, and one back tab 406 extends from second bottom side panel 398 along fold line 414. Each front tab 404 is separated from outer front panel 320 and inner front panel 322 by a cut line 416. Each back tab 406 is separated from back panel 316 by a cut line 418, and further separated from respective top side panels 348 and 350 by a cut line 420. In the exemplary embodiment, cut lines 420 are defined at an angle 422, in other embodiments, cut lines 420 may be any suitable shape, size, and/or configuration that enables heat-reflective blank 300 and/or container 450 to function as described herein.

In the exemplary embodiment, heat-reflective blank 300 has a heat-reflective film or a thermal film 302 formed on at least a portion of interior surface 304. Heat-reflective blank 300 is used to form container 450. Thermal film 302 may be formed, for example, laminated, to heat-reflective blank 300 using a process with one or more machines, as described in more detail below. In the exemplary embodiment, thermal film 302 is formed to interior surface 304 of top panel 314 and substantially covers top panel 314. Additionally, thermal film 302 is formed to interior surface 304 of first top side panel 348, second top side panel 350, vent assembly 364, and vent assembly 366 and substantially covers each panel 348, 350, 364, and 366. Additionally and/or alternatively, thermal film 302 is coupled to interior surface 304 of any suitable panel(s). For example, tuck flap 312, back panel 316, bottom panel 318, and/or bottom side panels 396 and/or 398.

To construct container 450 shown in FIG. 4 from heat-reflective blank 300 shown in FIG. 3, bottom side panels 396 and 398 are rotated about respective fold lines 400 and 402 toward interior surface 304 to form a generally right angle with bottom panel 318. Each bottom side panel 396 and 398 forms a respective bottom side wall 454 and 456. Front tabs 404 are each rotated about respective fold lines 408 and 412 toward interior surface 304 of each bottom side panel 396 and 398 to form a generally right angle with each bottom side panel 396 and 398. Outer front panel 320 is rotated about fold line 330 toward interior surface 304 to form a generally right angle with bottom panel 318. Exterior surface 306 of each front tab 404 is adjacent to interior surface 304 of outer front panel 320. Inner front panel 322 is rotated about hinge line 332 such that interior surface 304 of each front tab 404 is adjacent to interior surface 304 of inner front panel 322. As such, when inner front panel 322 is rotated about hinge line 332, front tabs 404 extend between inner front panel 322 and outer front panel 320. In the exemplary embodiment, tabs 342 extending from inner front panel 322 interconnect with openings 452 formed by tabs 342 extending from outer front panel 320 to facilitate securing inner front panel 322 against front tabs 404 and outer front panel 320. Outer front panel 320, inner front panel 322, and front tabs 404 define a bottom front wall 458.

Each back tab 406 is rotated about respective fold lines 410 and 414 toward interior surface 304 to form a generally right angle with each respective bottom side panel 396 and 398. Back panel 316 is rotated about fold line 328 toward interior surface 304 to form a generally right angle with bottom panel 318. In the exemplary embodiment, exterior surface 306 of each back tab 406 is adjacent to interior surface 304 of back panel 316. Back panel 316 and back tabs 406 define a back wall 460. Each top side panel 348 and 350 is rotated about respective fold lines 352 and 354 toward interior surface 304 to form generally right angles with top panel 314. Each top side panel 348 and 350 define a top side wall (not shown). Tuck flap 312 is rotated about fold line 324 toward interior surface 304 to form a generally right angle with top panel 314. When tuck flap 312 is folded about fold line 324, tab 346 extends from top panel 314. To close container 450, top panel 314 is rotated about fold line 326 toward interior surface 304 to be aligned substantially parallel to bottom panel 318. When top panel 314 is rotated into place, exterior surface 306 of each top side panel 348 and 350 is adjacent to interior surface 304 of respective bottom side panels 396 and 398. Further, when top panel 314 is rotated into place, exterior surface 306 of tuck flap 312 is adjacent to exterior surface 306 of inner front panel 332. Once container 450 is constructed, container 450 may hold any suitable item or items, for example, but not limited to, a food item, such as, a pizza, and thermal film 302 is positioned adjacent the item, such as adjacent to a top surface of the item. In the exemplary embodiment, thermal film 302 facilitates to increase the reflection of heat from the contents of container 450.

Furthermore, in some embodiments, a corrugated insert (not shown) may be placed in container 450 at bottom panel 318. The corrugation insert may be defined in any shape, for example, square or circular to correspond to the shape of the contents therein. The corrugation of the insert facilities isolating the contents from bottom panel 318, absorbing hot moisture from the contents, and absorb oil from the contents. As such, the corrugated insert acts as a moisture barrier at bottom panel 318. Additionally, or alternatively, bottom panel 318 may be coated with a layer of moisture resistant film, such as a wax, to provide the moisture barrier.

In the example embodiment, when container 450 is in a closed position, vent assemblies 364 and 366 are formed on top panel 314 and are a raised triangular cross-sectional shape. More specifically, upper vent panels 370 and 384, and lower vent panels 368 and 382 fold and form vent 462 creating openings 464 at each end. Openings 464 are in air flow communication with the interior cavity of container 450 and a surrounding area outside of (i.e., ambient environment). As each top side panel 348 and 350 are rotated along fold lines 352 and 354, lower vent panels 368 and 382, which in the example embodiment have a greater width than upper vent panels 370 and 384, rotates along fold lines 372 and 386 into an upwards slope position, while upper vent panels 370 and 384 rotate respectively along fold lines 374, 376, 388, and 390 into a downwards slope position, creating openings 464, with fold lines 374 and 388 being an apex of openings 464.

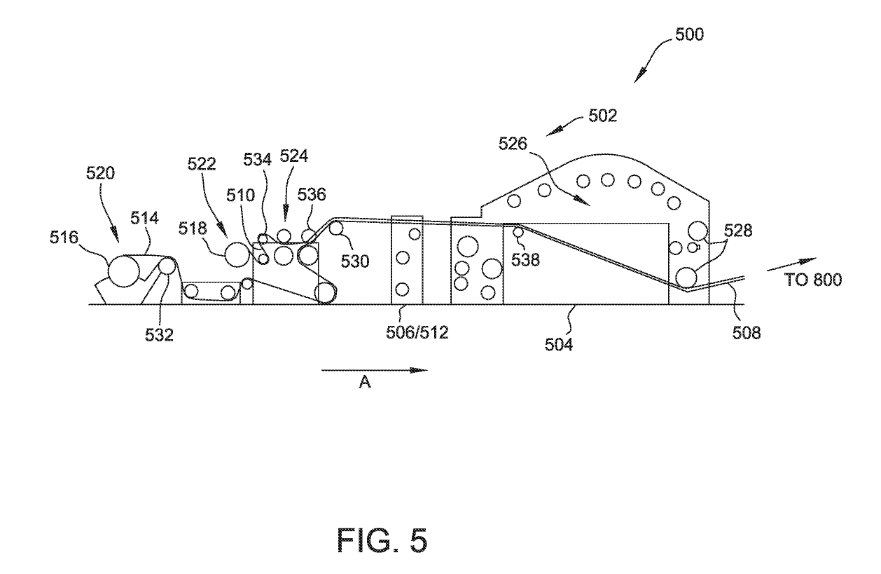

FIG. 5 is a schematic side view of a laminating machine 500 for forming heat-reflective blank 10 (shown in FIG. 1) and/or heat reflective blank 300 (shown in FIG. 3). As used herein, the terms “downward,” “down,” and variations thereof refer to a direction from a top 502 of machine 500 toward a surface or floor 504 on which machine 500 is supported, and the terms “upward,” “up,” and variations thereof refer to a direction from floor 504 on which machine 500 is supported toward top 502 of machine 500. Further, as used herein, “operational control communication” refers to a link, such as a conductor, a wire, and/or a data link, between two or more components of machine 500 that enables signals, electric currents, and/or commands to be communicated between the two or more components. The link is configured to enable one component to control an operation of another component of machine 500 using the communicated signals, electric currents, and/or commands.

In the exemplary embodiment, components of stations 520, 522, 524, 526, 528, and/or 530 (described in more detail below) are in communication with a control system 506. Control system 506 is configured to control and/or monitor components of machine 500 to form a laminated sheet material 508. In the exemplary embodiment, control system 506 includes computer-readable instructions for performing the methods described herein. In one embodiment, an operator can select a position of a thermal film sheet material 510 by machine 500 using control system 506, and control system 506 performs the corresponding method using the components of machine 500. Control system 506 is shown as being centralized within machine 500, however, control system 506 may be a distributed system throughout machine 500, within a building housing machine 500, and/or at a remote control center. Control system 506 includes a processor 512 configured to perform the methods and/or steps described herein. Further, many of the other components described herein include a processor. As used herein, the term “processor” is not limited to integrated circuits referred to in the art as a processor, but broadly refers to a controller, a microcontroller, a microcomputer, a programmable logic controller (PLC), an application specific integrated circuit, and other programmable circuits, and these terms are used interchangeably herein. It should be understood that a processor and/or control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels may include, without limitation, sensors and/or computer peripherals associated with an operator interface, such as a mouse and a keyboard. Further, in the exemplary embodiment, output channels may include, without limitation, a control device, an operator interface monitor, and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a PLC cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, machine control commands. The execution of sequences of instructions is not limited to any specific combination of hardware circuitry and software instructions.

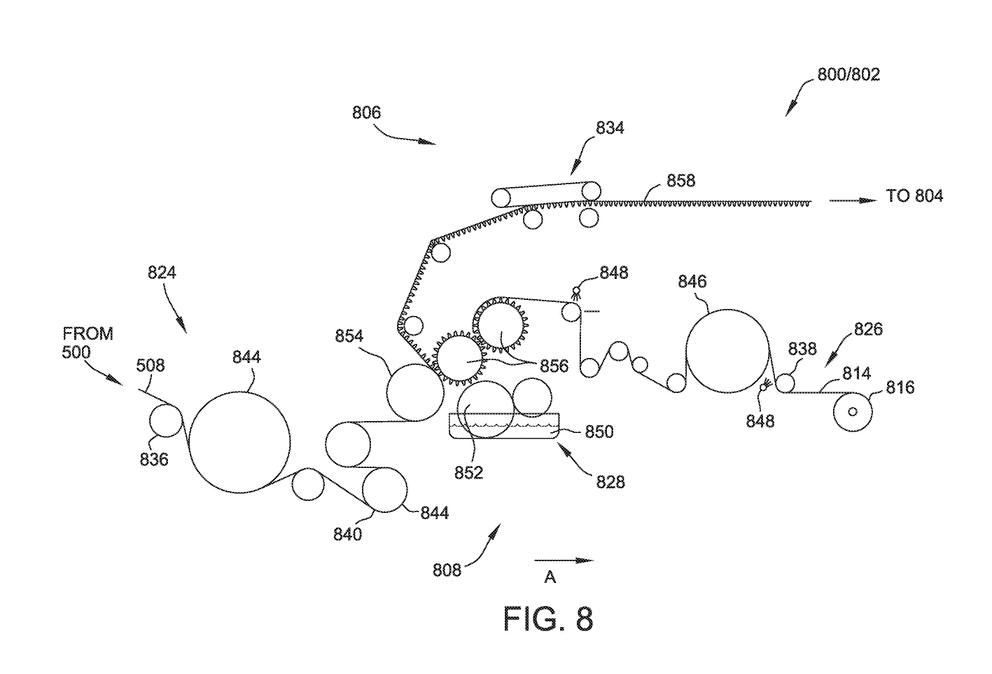

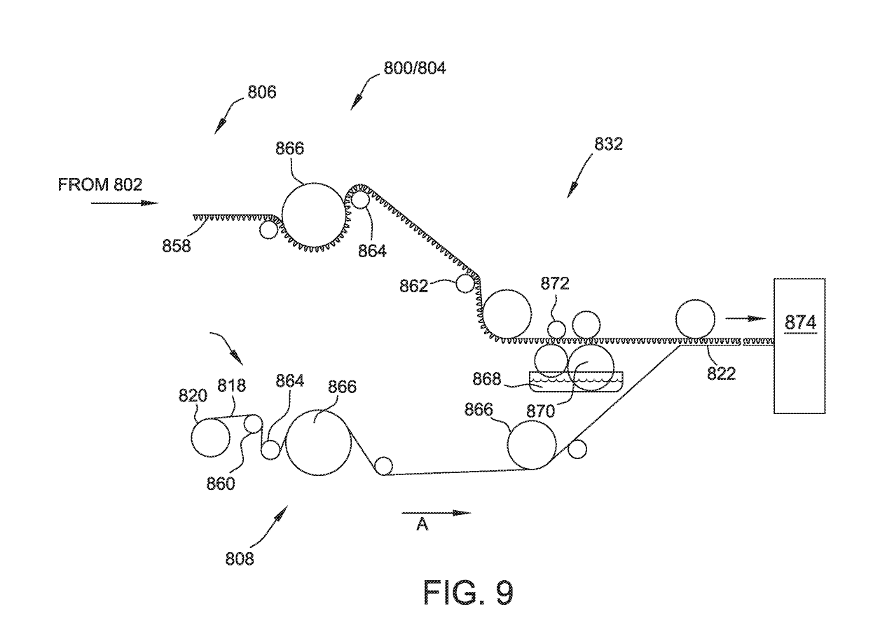

In FIG. 5, arrow A shows a direction of movement of sheet materials through machine 500 for forming laminated sheet material 508. Further, the head of arrow A indicates a “downstream” or “forward” direction and the tail of arrow A indicates an “upstream” or “backward” direction. The term “front” as used herein with respect to movement through machine 500 refers to the downstream end of the sheet materials, and the term “rear” as used herein with respect to movement through machine 500 refers to the upstream end of the sheet materials. In the exemplary embodiment, laminating machine 500 is a continuous process machine such that one or more rolls of sheet material, for example, a first linerboard sheet material 514 from a first linerboard roll 516 and thermal film sheet material 510 from thermal film roll 518 are laminated together forming laminated sheet material 508 that is channeled into a corrugating machine 800 described below in reference to FIGS. 8 and 9. In other embodiments, laminating machine 500 is any other type of machine that facilitates forming laminated sheet material 508 as described herein. For example, laminating machine 500 may form a roll of laminated sheet material to be transported to a corrugating machine in another location.

In the exemplary embodiment, thermal film sheet material 510 includes thermal film 104 and 302 (shown in FIGS. 1 and 3 respectively), for example, aluminum foil, metalized polymer films, metalized paper, and/or non-metalized polymer films as described above. Linerboard sheet material 514 includes, for example, paperboard and/or any other suitable material that facilitates formation of a corrugated sheet material as described herein.

Referring to FIG. 5, in the exemplary embodiment, laminating machine 500 includes a linerboard unwind station 520, a thermal film unwind station 522, a laminator station 524, a heating station 526, and a chilling station 528. More specifically, linerboard unwind station 520, thermal film unwind station 522, laminator station 524, heating station 526, and chilling station 528 are connected by a transport system 530, such as any suitable roller system and/or motorized device(s) configured to move sheet material 508, 510, and/or 514 through machine 500. In the exemplary embodiment, linerboard unwind station 520 facilitates receiving linerboard roll 516. Linerboard unwind station 520 unrolls linerboard sheet material 514 from linerboard roll 516 and channels linerboard sheet material 514 to laminator station 524 through any suitable and/or configuration of components 532, such as rollers, actuators, pumps, and/or other devices for moving linerboard sheet material 514 downstream towards laminator station 524. In the exemplary embodiment, thermal film unwind station 522 facilitates receiving at least one thermal film roll 518. Thermal film unwind station 522 unrolls thermal film sheet material 510 from thermal film roll 518 and channels thermal film sheet material 510 to laminator station 524 through any suitable and/or configuration of components 534, such as rollers, actuators, pumps, and/or other devices for moving thermal film sheet material 510 downstream towards laminator station 524.

In the exemplary embodiment, laminator station 524 is downstream from both linerboard unwind station 520 and thermal film unwind station 522 and facilitates coupling thermal film sheet material 510 to linerboard sheet material 514 and forming laminated sheet material 508. Laminator station 524 includes any suitable number and/or configuration of components 536, such as rollers, actuators, pumps, cutters, glue applicators, pressers, and/or other devices for forming laminated sheet material 508 and moving laminated sheet material 508 downstream towards heating station 526. In the exemplary embodiment, laminator station 524 applies a layer of glue to at least one thermal film sheet material 510 and selectively positions and presses thermal film sheet material 510 on linerboard sheet material 514. In alternative embodiments, thermal film sheet material 510 is coupled to linerboard sheet material 514 via any other process with any other adhesive that enables laminated sheet material 508 to function as described herein.

In some embodiments, heating station 526 is downstream from laminator station 524 and facilitates heating laminated sheet material 508 to cure the glue/lamination. Heating station 526 includes any suitable number and/or configuration of components 538, such as rollers, actuators, pumps, heaters, and/or other devices for heating laminated sheet material 508 and moving laminated sheet material 508 downstream towards chilling station 528. In other embodiments, chilling station 528 is downstream from heating station 526 and facilitates cooling laminated sheet material 508 such that laminated sheet material 508 may be channeled into corrugating machine 800. In alternative embodiments, chilling station 528 facilitates rolling laminated sheet material into a laminated roll (not shown). Chilling station 528 includes any suitable number and/or configuration of components 540, such as rollers, actuators, pumps, chillers, and/or other devices for cooling laminated sheet material 508.

During operation of laminating machine 500 to form laminated sheet material 508, linerboard roll 516 is received in linerboard unwind station 520 and is unrolled as linerboard sheet material 514. Thermal film roll 518 is received in thermal film unwind station 522 and is unrolled as thermal film sheet material 510. Transport system 530 feeds both linerboard sheet material 514 and thermal film sheet material 510 to laminator station 524. Within laminator station 524, an applicator applies a layer of glue to one surface of thermal film sheet material 510 while one surface of linerboard sheet material 514 is positioned adjacent to the glue layer. After the layer of glue is applied to thermal film sheet material 510, linerboard sheet material 514 is pressed, via a pressure roller, against thermal film sheet material 510 and the layer of glue, such that thermal film sheet material 510 and linerboard sheet material 514 couple to each other forming laminated sheet material 508. In alternative embodiments, laminating machine 500 forms laminated sheet material 508 via any other process that enables laminated sheet material 508 to function as described herein.

After laminated sheet material 508 is formed, in some embodiments, transport system 530 channels laminated sheet material 508 through heating station 526. Heating station 526 applies heat to laminated sheet material 508 and cures the glue that laminates thermal film sheet material 510 to linerboard sheet material 514. Transport system 530 then channels laminated sheet material 508 through chilling station 528. Chilling station 528 cools laminated sheet material 508 such that laminated sheet material 508 may be channeled directly to corrugating machine 800 or rolled into a laminated roll.

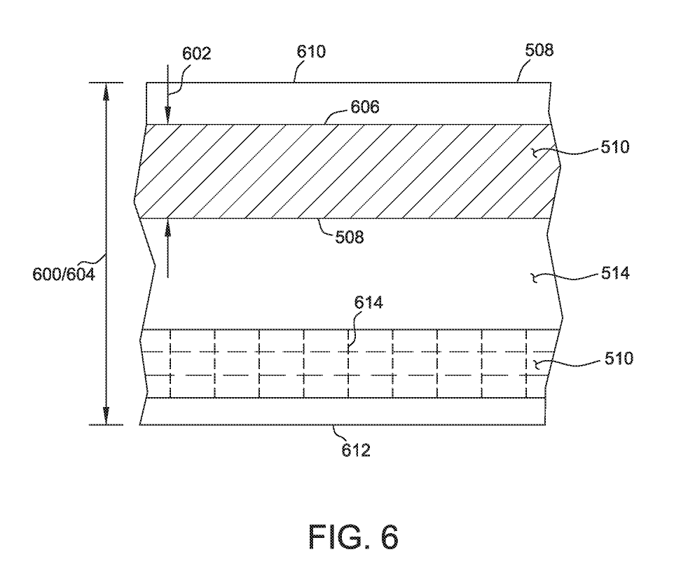

FIG. 6 is a plan view of laminated sheet material 508 that may be formed from laminating machine 500 (shown in FIG. 5). Laminated sheet material 508 includes linerboard sheet material 514 and at least one thermal film sheet material 510. Linerboard sheet material 514 generally has a width 600 and thermal film sheet material 510 has a width 602. Laminated sheet material 508 also has a width 604 that corresponds to linerboard sheet material width 600. In the exemplary embodiment, thermal film sheet material width 602 is less than linerboard sheet material width 600. As such, thermal film sheet material 510 is selectively positioned only on a portion of linerboard sheet material 514 in laminating machine 500. In an alternative embodiment, laminated sheet material 508 includes two or more thermal film sheet materials 510.

In the exemplary embodiment, laminated sheet material 508 corresponds to interior surface 12 of heat-reflective blank 10 (shown in FIG. 1) or interior surface 304 of heat-reflective blank 300 (shown in FIG. 3) and thermal film sheet material 510 corresponds to thermal film 104 (shown in FIG. 1) or thermal film 302 (shown in FIG. 3). For example, a first edge 606 of thermal film sheet 510 substantially corresponds to fold line 32 (shown in FIG. 1) of heat-reflective blank 10 and an opposite second edge 608 substantially corresponds to fold line 34 (shown in FIG. 1) of heat-reflective blank 10. In alternative embodiments, first and second edges 606 and 608 may be any shape, for example, a sinusoidal shape forming a substantial circular thermal film 104 shape, to facilitate the shape of thermal film 104 on heat-reflective blank 10. Additionally, on the exemplary embodiment, thermal film sheet material 510 is positioned adjacent a first edge 610 of laminated sheet material 508. In alternative embodiments, thermal film sheet material 510 may be positioned adjacent to an opposite second edge 612 of laminated sheet material 508. In other embodiments, thermal film sheet material 510 may extend along the entire linerboard sheet material width 600 such that the entire heat-resistant blank is formed with a layer of thermal film 510.

Furthermore, in some embodiments, thermal film sheet material 510 may be laminated to linerboard sheet material 514 in a glue pattern 614 that facilitates forming air pockets that act as a thermal barrier between thermal film sheet material 510 and linerboard sheet material 514 to increase heat retention. In other embodiments, the glue used for lamination may include insulating material, such as including a filler with insulating properties to further increase heat retention of container 200 (shown in FIG. 2) and/or container 450 (shown in FIG. 4) thereof. Additionally, the glue used for lamination facilities easy removal of thermal film sheet material 510 such that container 200 and/or 450 may be recycled.

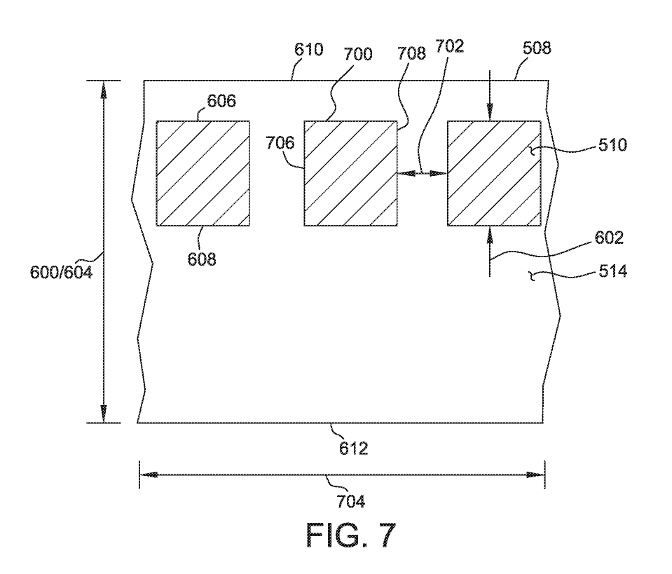

FIG. 7 is a plan view of an alternate embodiment of laminated sheet material 508 that may be formed from laminating machine 500 (shown in FIG. 5). Laminated sheet material 508 includes linerboard sheet material 514 and thermal film sheet material 510 such that thermal film sheet material width 602 is less then linerboard sheet material width 600. Additionally, thermal film sheet material 510 is segmented 700 and spaced a predetermined distance 702 apart from one another along a length 704 of laminated sheet material 508. As such, thermal film sheet material 510 is positioned only on a portion of linerboard sheet material 514 in laminating machine 500 through a cutter therein.

In the exemplary embodiment, laminated sheet material 508 corresponds to interior surface 12 (shown in FIG. 1) of heat-reflective blank 10 (shown in FIG. 1) or interior surface 304 of heat-reflective blank 300 (shown in FIG. 3) and thermal film sheet material 510 corresponds to thermal film 104 (shown in FIG. 1) or thermal film 302 (shown in FIG. 3). For example, first edge 606 of thermal film sheet 510 substantially corresponds to fold line 32 (shown in FIG. 1) of heat-reflective blank 10, and second edge 608 substantially corresponds to fold line 34 (shown in FIG. 1) of heat-reflective blank 10. Additionally, for example, a first segmented edge 706 of thermal film sheet 510 substantially corresponds to fold line 64 (shown in FIG. 1) of heat-reflective blank, and an opposite second segmented edge 708 substantially corresponds to fold line 66 (shown in FIG. 1) of heat-reflective blank 10. In the exemplary embodiment, each thermal film segment 700 is substantially square in shape. In alternative embodiments, each thermal film segment 700 may be any shape, for example, a circle, rectangle, and/or polygon, to facilitate the shape of thermal film 104 on heat-reflective blank 10. Additionally, on the exemplary embodiment, each thermal film sheet segment 700 is positioned adjacent first edge 610 of laminated sheet material 508. In alternative embodiments, thermal film sheet material 510 may be positioned adjacent to second edge 612 of laminated sheet material 508 or in any other pattern that facilitates forming heat-reflective blank 10.

FIG. 8 is a schematic side view of a first section 802 of a corrugating machine 800 for forming heat-reflective blank 10 (shown in FIG. 1) and heat reflective blank 300 (shown in FIG. 3). FIG. 9 is a schematic side view of a second section 804 of corrugating machine 800. As used herein, the terms “downward,” “down,” and variations thereof refer to a direction from a top 806 of machine 800 toward a surface or floor 808 on which machine 800 is supported, and the terms “upward,” “up,” and variations thereof refer to a direction from floor 808 on which machine 800 is supported toward top 806 of machine 800. Further, as used herein, “operational control communication” refers to a link, such as a conductor, a wire, and/or a data link, between two or more components of machine 800 that enables signals, electric currents, and/or commands to be communicated between the two or more components. The link is configured to enable one component to control an operation of another component of machine 800 using the communicated signals, electric currents, and/or commands. Additionally, machine 800 may be communicatively coupled to laminating machine 500 (shown in FIG. 5).

In the exemplary embodiment, components of stations 824, 826, 828, 830, 832, and/or 834 (described in more detail below) are in communication with a control system 810. Control system 810 is configured to control and/or monitor components of machine 800 to form heat-reflective blank 10 and 300. In the exemplary embodiment, control system 810 includes computer-readable instructions for performing the methods described herein. In one embodiment, an operator can select a speed of machine 800 using control system 810, and control system 810 performs the corresponding method using the components of machine 800. Control system 810 is shown as being centralized within machine 800, however, control system 810 may be a distributed system throughout machine 800, within a building housing machine 800, and/or at a remote control center. Control system 810 includes a processor 812 configured to perform the methods and/or steps described herein. Further, many of the other components described herein include a processor.

In FIGS. 8 and 9, arrow A shows a direction of movement of sheet materials through machine 800. Further, the head of arrow A indicates a “downstream” or “forward” direction and the tail of arrow A indicates an “upstream” or “backward” direction. The term “front” as used herein with respect to movement through machine 800 refers to the downstream end of the sheet materials, and the term “rear” as used herein with respect to movement through machine 800 refers to the upstream end of the sheet materials. In the exemplary embodiment, corrugating machine 800 is a continuous process machine such that one or more sheet materials, for example, laminated sheet material 508 as described in reference to FIGS. 5-7, a medium sheet material 814 from a medium roll 816, and a second linerboard sheet material 818 from a second linerboard roll 820, are coupled together forming a corrugated sheet material 822. In other embodiments, corrugating machine 800 is any other type of machine that facilitates forming corrugated sheet material 822 as described herein.

In the exemplary embodiment, medium sheet material includes, for example, paperboard and/or any other suitable material that facilitates forming a corrugated layer as described herein. Linerboard sheet material 818 includes, for example, paperboard and/or any other suitable material that facilitates formation of a corrugated sheet material 822 as described herein. In the exemplary embodiment, linerboard sheet material 818 is similar to linerboard sheet material 514 (shown in FIG. 5). In alternative embodiments, linerboard sheet material 818 is different than linerboard sheet material 514.

Referring to FIGS. 8 and 9, in the exemplary embodiment, corrugating machine 800 includes a lamination receiving station 824, a medium unwind station 826, a first adhesive station 828, a linerboard unwind station 830, and a second adhesive station 832. More specifically, lamination receiving station 824, medium unwind station 826, first adhesive station 828, linerboard unwind station 830, and second adhesive station 832 are connected by a transport system 834, such as any suitable roller system and/or motorized device(s) configured to move sheet materials 508, 814, 818, and/or 822 through machine 800. In the exemplary embodiment, lamination receiving station 824 facilitates receiving laminated sheet material 508 directly from laminating machine 500. Lamination receiving station 824 channels laminated sheet material 508 to first adhesive station 828 through any suitable and/or configuration of components 836, such as rollers, actuators, pumps, and/or other devices for moving laminated sheet material 508 downstream towards first adhesive station 828. In the exemplary embodiment, medium unwind station 826 facilitates receiving medium film roll 816. Medium film unwind station 826 unrolls medium sheet material 814 from medium roll 816 and channels medium sheet material 814 to first adhesive station 828 through any suitable and/or configuration of components 838 as part of transport system 834, such as rollers, actuators, pumps, and/or other devices for moving medium sheet material 814 downstream towards first adhesive station 828.

In the exemplary embodiment, first adhesive station 828 is downstream from both lamination receiving station 824 and medium unwind station 826 and facilitates adhering laminated sheet material 508 to corrugated medium sheet material 814. First adhesive station 828 includes any suitable number and/or configuration of components 840, such as one or more rollers 842, one or more preheating rollers 844, one or more preconditioning rollers 846, one or more stream showers 848, a starch bath 850, one or more starch applicator rollers 852, one or more pressure rollers 854, one or more corrugation forming rollers 856, and/or other devices for facilitating corrugating medium sheet material 814 and coupling medium sheet material 814 to laminated sheet material 508 forming a single-sided corrugation sheet 858. In addition, first adhesive station 828 and components 840 thereof facilitate moving single-sided corrugation sheet 858 downstream towards second adhesive station 832. In alternative embodiments, laminated sheet material 508 is adhered to corrugated medium sheet material 814 via any other process that enables heat-reflective blank 10 and 300 to function as described herein.

Further, in the exemplary embodiment, linerboard unwind station 830 facilitates receiving linerboard roll 820. Linerboard unwind station 830 unrolls linerboard sheet material 818 from linerboard roll 820 and channels linerboard sheet material 818 to second adhesive station 832 through any suitable and/or configuration of components 860, such as rollers, actuators, pumps, and/or other devices for moving linerboard sheet material 818 downstream towards second adhesive station 832.

In the exemplary embodiment, second adhesive station 832 is downstream from both first adhesive station 828 and linerboard unwind station 830 and facilitates adhering linerboard sheet material 818 to single-sided corrugation sheet 858. Second adhesive station 832 includes any suitable number and/or configuration of components 862, such as one or more rollers 864, one or more preheating rollers 866, a starch bath 868, one or more starch applicator rollers 870, one or more hold down rollers 872, and/or other devices for facilitating coupling single-sided corrugation sheet 858 to linerboard sheet material 818 to form a double-sided corrugated sheet material 822. In alternative embodiments, single-sided corrugation sheet 858 is adhered to linerboard sheet material 818 via any other process that enables corrugated sheet material 822 to function as described herein.

During operation of corrugating machine 800, corrugated sheet material 822 is formed. Laminated sheet material 508 is received in lamination receiving station 824. Medium roll 816 is received in medium unwind station 826 and is unrolled as medium sheet material 814. Linerboard roll 820 is received in linerboard unwind station 830 and is unrolled as linerboard sheet material 818. Both laminated sheet material 508 and medium sheet material 814 are channeled to first adhesive station 828 via transport system 834. At first adhesive station 828, medium sheet material 814 is preconditioned at preconditioning rollers 846 and steam showers 848 before being formed at corrugation forming rollers 856, which forms medium sheet material 814 in a corrugated shape. In the exemplary embodiment, the corrugations run along laminated sheet material width 604 (shown in FIGS. 6 and 7). Additionally, at first adhesive station 828, laminated sheet material 508 is preheated at preheating roller 844 before adhering to corrugated medium sheet material 814 via starch applied by starch applicator roller 852 and pressure applied by pressure roller 854. In alternative embodiments, any other type of adhesive, for example, glue, may be applied by starch applicator roller 852. In the exemplary embodiment, corrugated medium sheet material 814 is adhered to linerboard sheet material 514 (shown in FIGS. 5-7) of lamented sheet material 508 such that linerboard sheet material 514 is positioned between thermal film sheet material 510 (shown in FIGS. 5-7) and corrugated medium sheet material 814.

Once laminated sheet material 508 is adhered to corrugated medium sheet material 814, transport system 834 feeds single-sided corrugation sheet 858 to second adhesive station 832. Additionally, linerboard roll 820 is received in linerboard unwind station 830 and is unrolled as linerboard sheet material 818. Linerboard sheet material 818 is channeled to second adhesive station 832 via transport system 834. At second adhesive station 832, single-sided corrugation sheet 858 is preheated at preheating roller 866 and starch is applied by starch applicator roller 870 and hold down roller 872. Additionally, linerboard sheet material 818 is preheated at preheating rollers 866 before being adhered to medium sheet material 814 to form double-sided corrugated sheet material 822. In alternative embodiments, any other type of adhesive, for example, glue, may be applied by starch applicator roller 870. In the exemplary embodiment, linerboard sheet material 818 is adhered to corrugated medium sheet material 814 such that corrugated medium sheet material 814 is positioned between laminated sheet material 508 and linerboard sheet material 818. Additionally, thermal film sheet material 510 is on an outer surface of corrugated sheet material 822. Corrugated sheet material 822 may then feed into a converting machine 874. In alternative embodiments, corrugated sheet material 822 may be rolled into a corrugated roll (not shown) and transported a converting machine.

Converting machine 874 facilitates converting corrugated sheet material 822 with thermal film sheet layer 510 to one or more heat-reflective blanks and/or containers, such as heat-reflective bank 10 and/or container 200 and heat-reflective blank 300 and/or container 450. In the exemplary embodiment, converting machine 874 includes a cutting station, such as a rotary die cutter, to print, score, cut, fold, glue, and/or stack blanks and containers therein. More specifically, converting machine 874 facilitates cutting corrugated sheet material 822 into individual heat-reflective blanks. Additionally, converting machine 874 slits and scores the heat-reflective blanks, for example fold lines 32 and 34, and cut lines 42 and 44 (all shown in FIG. 1) to facilitate folding heat-reflective blank 10 into container 200. Further, in the exemplary embodiment, converting machine 874 facilitates folding and gluing heat-reflective blanks into containers, as described above in reference to FIGS. 2 and 4, via a series of components.

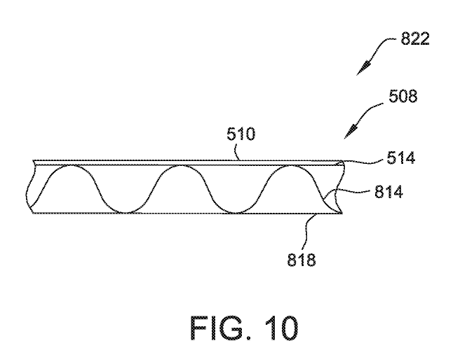

FIG. 10 is a cross-sectional view of corrugated sheet material 822 that may be formed from corrugating machine 800 (shown in FIGS. 8 and 9). Corrugated sheet material 822 includes an outer layer of linerboard sheet material 818, a middle layer of corrugated medium sheet material 814, a middle layer of linerboard sheet material 514, and an outer layer of thermal film sheet material 510. Corrugated medium sheet material 814 is positioned between the two linerboard sheet materials 818 and 514.

Although at least two machines in series are described above, it should be understood that any machine that applies a thermal film material to an interior surface of a top panel of a blank can be used to form the heat-reflective blanks described herein.

The above-described method and machine enable mass production of a heat-reflective blank including a thermal film coupled thereto. More specifically, by using the method and/or machine described herein, the thermal film is applied to a blank in a timely and cost effective manner. Further, the above-described machine applies the thermal film to a linerboard before forming a corrugated sheet material that is cut into the heat-reflective blanks, rather than applying the thermal film after the blanks are formed. More specifically, the lamination machine described herein applies the thermal film to a linerboard, and then feeds both directly to the corrugating machine to form the corrugated sheets and the heat-reflective blanks. Additionally, the containers as described herein provide features, such as heat-reflective foils, ventilation, moisture barrier inserts, and others, that retain heat of the contents of the containers, as well as, increase crispness retention of the contents.

Exemplary embodiments of a machine and a method for forming a heat-reflective blank are described above in detail. The machine and method are not limited to the specific embodiments described herein, but rather, components of the machine and/or steps of the method may be utilized independently and separately from other components and/or steps described herein. For example, the methods may also be used in combination with other corrugating machines and methods, and are not limited to practice with only the machine and method as described herein. For example, at least some components of the machine described herein can be used with other machines. Rather, the exemplary embodiment can be implemented and utilized in connection with many other film applying applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for forming a heat-reflective blank comprising:
laminating at least one thermal film sheet at a predetermined position on a first linerboard sheet such that a laminated sheet is formed;
feeding the laminated sheet into a corrugating machine; and
coupling the laminated sheet to a corrugated medium sheet and a second linerboard sheet such that a corrugated sheet is formed, wherein the corrugated medium sheet is between the first linerboard sheet and the second linerboard sheet and the thermal film sheet is positioned on an outer surface of the corrugated sheet.

2. The method in accordance with claim 1 further comprising cutting the corrugated sheet into a plurality of heat-reflective blanks.

3. The method in accordance with claim 1 further comprising positioning the at least one thermal film sheet on the first linerboard sheet such that a width of the first linerboard sheet is greater than a width of the at least one thermal film sheet.

4. The method in accordance with claim 3, wherein the at least one thermal film sheet is positioned on a first edge of the first linerboard sheet.

5. The method in accordance with claim 1 further comprising continuously laminating a first thermal film sheet at a first predetermined position on the first linerboard sheet and a second thermal film sheet at a second predetermined position on the first linerboard sheet, wherein the first thermal film sheet is adjacent second thermal film sheet.

6. The method in accordance with claim 1 further comprising positioning the at least one thermal film sheet on the first linerboard sheet such that a plurality of thermal film pieces are spaced at a predetermined distance along a length of the first linerboard sheet.

7. The method in accordance with claim 1 further comprising converting the heat-reflective blanks to heat-reflective boxes.

8. The method in accordance with claim 1 further comprising continuously feeding the laminated sheet into the corrugating machine such that the corrugated sheet is formed through a continuous process.
